(19) United States
(12) Patent Application Publication
(10) Pub. No.: US 2019/0170117 A1
(43) Pub. Date: Jun. 6, 2019

(54) WIND FARM WITH AUTONOMOUS PHASE ANGLE REGULATION

(71) Applicant: SENVION GmbH, Hamburg (DE)

(72) Inventor: Heinz-Hermann LETAS, Bovenau (DE)

(73) Assignee: SENVION GmbH, Hamburg (DE)

(21) Appl. No.: 16/209,374

(22) Filed: Dec. 4, 2018

(30) Foreign Application Priority Data
Dec. 6, 2017 (DE) 10 2017 011 235.5

(51) Int. Cl. F03D 7/02; F03D 9/25; H02J 3/16; H02J 3/38

(52) U.S. Cl. CPC F03D 7/0284; H02J 3/386; H02J 3/16; F03D 9/257

(57) ABSTRACT

A wind farm comprising wind energy installations, a farm-internal network and a collecting station, wherein a central transmission line is connected to the collecting station. The wind energy installations each have controllers for active/reactive power, which act on the respective converter depending on the phase angle. The wind farm has an autonomous reference angle generator, which generates a reference angle (ϕₑₓₜ) for an artificial coordinate system defining an active and reactive axis in the farm network. The converters of the wind energy installations are thus externally controlled in terms of phase. The wind energy installation does not effect feeding with exactly the phase angle (ϕ_{lcl}) such as prevails at its connecting terminals, but rather with that predefined externally.

### CROSS-REFERENCE TO RELATED APPLICATIONS

This application claims the priority of German Application No. 10 2017 011 235.5, filed Dec. 6, 2017, the entire contents of which are incorporated herein by reference.

### FIELD OF THE INVENTION

The invention relates to a wind farm with autonomous phase regulation. Said wind farm comprises a plurality of wind energy installations for generating electrical energy, which are connected to a collecting station via a farm-internal network. A central transmission line for connection to an energy transmission network is connected to said collecting station.

### BACKGROUND OF THE INVENTION

Remote wind farms, in particular those on the high seas, are often connected via a special transmission line. In the case of such transmission links over relatively long distances there are often restrictions with regard to the reactive power to be transmitted. This is especially pronounced in the case of DC links, which in principle cannot transmit any reactive power at all.

In the case of a DC link (high-voltage direct-current transmission), at the wind farm a rectifier is provided for converting the three-phase current flowing in the park-internal network to direct current, in order thus to transmit it via a DC connection. A corresponding remote station is arranged at the shore and converts the transmitted direct current into three-phase current again and feeds it into the transmission network at a coupling point (PCC).

For the rectifier arranged at a collecting station at the wind farm there are two different main types: one main type has controlled IGBTs as active elements, and the other has uncontrolled elements with power diodes (for example DRU type from Siemens).

The latter variant is significantly simpler in its construction and demands only little outlay. Overall it is less complex and affords major advantages with regard to important operating parameters, in particular power, robustness, compactness, etc. However, this variant has a serious disadvantage: it cannot take up any reactive power from the farm-internal network. This has the consequence that the wind energy installations cannot generate reactive power arbitrarily, but rather in total exactly only as much as to compensate for reactive power losses in the farm-internal network owing to reactive current losses through the latter's lines, transformers and other operating equipment.

However, modern wind energy installations are designed to impress a specified reactive power. That is based on the premise that the network to which the wind energy installation is connected can transmit reactive power. However, it is precisely this premise which does not apply to use in a remote wind farm such as the offshore wind farm connected via a DC link as described by way of example here. Reactive power cannot be transmitted; that is at odds with the property of modern wind energy installations of impressing a specific reactive power. There is a mismatch. In this respect, the farm-internal network is overdetermined in terms of reactive power.

It is known to combat that by conventional means, for example the provision of STATCOMs or other types of phase shifters. All this requires additional apparatuses, which is costly in terms of production and leads to more complexity with correspondingly greater susceptibility to faults.

### SUMMARY OF THE INVENTION

According to some embodiments, in a wind farm comprising a plurality of wind energy installations which each have a generator driven via a rotor with a converter for generating electrical energy and are connected to a farm-internal network, which connects the wind energy installations to a collecting station, wherein a central transmission line for connection to an energy transmission network is connected to the collecting station, wherein a phase angle is a measure of a phase shift between current and voltage in the farm-internal network, and wherein the wind energy installations each have controllers for active/reactive power, which act on the respective converter depending on the phase angle, an autonomous reference angle generator is provided in the wind farm and generates a reference angle for a coordinate system defining an active and reactive axis in the farm network, and the converters of at least one participating portion of the wind energy installations are externally controlled in terms of phase by virtue of the reference angle generated by the reference angle generator being applied to the active/reactive power controller of the respective wind energy installation via a signal line.

Firstly, some terms used shall be explained:

A reference angle generator is understood to mean a unit which generates a reference angle with respect to the coordinate system in the farm-internal network (reference phase angle or reference angle for short). The reference angle generator also generates a reference frequency for the farm-internal network.

A stationary coordinate system is understood to mean a coordinate system which does not rotate. One example thereof is the stationary coordinate system of a three-phase system in which three voltage phasors rotate for the three phases. The absolute angular position of the coordinate system need not necessarily be zero, i.e. the latter can be “tilted”. This angular position can vary (floating zero angle).

In some aspects, the invention is based on the concept of modifying the regulation of the wind energy installations together with their respective converter in interaction with the farm-internal network such that the reactive powers in the wind farm compensate for one another as much as possible. This can be achieved by intervention in the regulation of the wind energy installation with its converter, without this necessitating costly additional hardware, such as phase shifters or STATCOMs. The invention recognized that this can be achieved by generating a dedicated, intrinsically entirely artificial coordinate system in the wind farm. It is conventionally the case that a wind energy installation detects the values for voltage and current at its connecting terminals to the farm-internal network, determines the actual phase angle therefrom and, on the basis thereof, performs a decomposition into active and reactive components. Regulation is effected in this real coordinate system (measured at the connecting terminals). The regulation then impresses active and reactive currents. The invention departs from this long-standing routine principle and now provides a dedicated wind-farm-autonomous, fundamentally artificial coordinate system that is taken as a basis for the regulation of the active and reactive power output of the wind energy installations. Thus, with regard to the active and reactive power, the local regulation of the wind energy installation does not employ its own local voltage phase system, but rather an artificial voltage reference system applied to the wind energy installation externally; it is thus externally controlled with regard to its phase.

This entails considerable advantages. Unexpectedly, this specification of the phase angle externally to the respective wind energy installation entails an additional degree of freedom. This is because now the wind energy installation does not feed in its power with exactly the phase angle such as prevails at its connecting terminals, but rather with that predefined externally. A difference can—and will—thus occur between the externally controlled phase angle impressed externally and the actual phase angle actually present at the connecting terminal of the respective wind energy installation. A certain independence arises in this respect. That has an effect such that if the wind energy installation effects feeding as with an intrinsically inappropriate reactive current owing to the phase angle impressed externally, a discrepancy arises which leads to a rotation of the local voltage phasors, as a result of which the active/reactive power distribution that is really output changes, specifically to an extent until it matches the physical boundary conditions specified by the farm network.

By virtue of aspects of the invention specifying the phase angle externally, it decouples the setting at the converter from the phase angle actually prevailing. By virtue of this decoupling, the wind energy installation can better adjust itself to the conditions actually prevailing in the wind farm. In particular, this counteracts the hazardous overdeterminacy such as otherwise arises in a wind farm as a result of the mandatory specification if the collecting station cannot transmit reactive power. Such a reactive-power-intolerant collecting station is present for example if a passive diode rectifier is used as rectifier of a high-voltage direct-current transmission.

Paradoxically, therefore, the external impression of the phase angle results in a greater degree of freedom for the wind energy installation. The overdeterminacy in the farm-internal network of a remote wind farm, in particular offshore wind farm, can thus be effectively avoided. Expensive additional equipment, such as STATCOMs or phase shifters, are not required. This is without parallel in the prior art.

Unexpectedly, it has been found that according to the invention, even with the phase being impressed externally, the converters are protected against excessively high currents. The invention has recognized that the apparent current can be kept constant despite the external phase specification. This is because fundamentally the situation is such that different combinations of active and reactive current can lead to the same apparent current. In this respect, therefore, it does not matter if a value which does not correspond to the actual conditions is specified by the external specification. A hazardous current limit value exceedance is thus avoided according to the invention.

A synthetic coordinate system is advantageously generated with the phase angle generated by the reference angle generator. Said coordinate system is floating with regard to its zero angle relative to the actual coordinate system of the farm-internal network per se. This means that the absolute phase angle can vary. This takes account of the fact that the absolute position of the coordinate system can vary. This affords the possibility that an adaptation can be effected by means of a suitable relative rotation between the synthetic coordinate system, on the one hand, and the actual phase angle at the respective wind energy installation, on the other hand. This basically enables an optimum self-adjustment.

Expediently, a phase monitor is provided, which detects an actual phase angle in the farm network and is configured to form a difference between the actual local phase angle in the farm network and the reference phase angle, to compare it with a limit value and to adjust the reference angle generator in the event of the limit value being exceeded. This makes it possible to ensure that the real conditions with regard to the phase angle do not deviate all that far from that of the synthetic coordinate system impressed by the reference phase angle. This maintains the stability of the regulation for active and reactive power of the respective wind energy installations and of the overall system. A monitoring module for the phase angle is advantageously provided. It is expediently configured to adjust the reference angle generator in the event of deviations. What is thus achieved is that in the event of excessively large deviations, the synthetic coordinate system is correspondingly tracked by adjustment of the reference angle generator. The system safety and stability are thus maintained.

The active/reactive power regulator of the respective wind energy installation is preferably provided with a feedforward controller. The latter is embodied such that it is based on the difference angle between the reference phase angle, on the one hand, and the actual local phase angle, on the other hand. In this way, the specification of an active and/or reactive power can be translated as it were into a corresponding variable in the externally impressed synthetic coordinate system with the reference phase angle. The feedforward control can thus be better adapted. It thus becomes more robust vis-à-vis possible deviations between impressed reference phase angle, on the one hand, and actual phase angle, on the other hand.

Preferably, the feedforward controller is configured to detect an active current actually output and to carry out a coordinate transformation into the synthetic coordinate system, wherein an adaptation of power specifications is preferably provided, in particular by means of an amplification by a cosine value of the reference phase angle. That is based on the insight that a type of amplification arises between the fictitious active current that results while taking account of the reference phase angle, on the one hand, and the real active current that results while taking account of the actual phase angle, on the other hand. This amplification can be compensated for in terms of amplitude by a corresponding feedforward controller that corrects the amplitude by a factor corresponding to the cosine of the angle difference between reference phase angle and actual phase angle. A faster and accurate regulation can thus be achieved by the feedforward controller. This improves the management behavior and the system stability.

Accordingly, the feedforward controller may be expediently furthermore configured to detect a reactive current actually output and to carry out a coordinate transformation into the synthetic coordinate system, wherein an adaptation of power specifications is preferably provided, in particular by means of an amplification by a sine value of the reference phase angle. The explanations given above in respect of the active current are analogously applicable.

It is not absolutely necessary for the reference phase angle according to the invention to be applied to all wind energy installations of the wind farm. It may be sufficient if only a portion of the wind energy installations participates therein; at least one must participate. The participating wind energy installations need not necessarily all obtain the same reference phase angle. It may furthermore be sufficient if the participating wind energy installations have different reference phase angles, preferably by taking account of a local offset for the reference phase angle. An adaptation to the respective individual conditions of the individual wind energy installations can thus be carried out. That is advantageous in particular if certain wind energy installations are arranged far away or are otherwise different with regard to their electrical parameters at the farm-internal network. Furthermore, it can be provided that the local offset is dependent on the operating point of the respective wind energy installation. This affords further possibilities for adaptation and for distribution of loads, in particular of the reactive power production, among the wind energy installations of the wind farm.

Different specifications of the reference phase angle can be carried out installation-specifically for the individual wind energy installations. However, it can also be provided that the participating wind energy installations are subdivided into groups, wherein the groups have different reference phase angles. The division into groups generally enables good regulatability with little outlay.

It is expedient, in particular, if at least one other of the wind energy installations of the wind farm is operated with an actual phase angle as reference phase angle, wherein the actual phase angle at the collecting station is preferably applied to this wind energy installation. This ensures that at least one wind energy installation is operated with the real parameters with regard to phase angle of the wind farm. This wind energy installation also functions as it were as a slack node with regard to the phase. That is expedient for the system stability. That holds true in particular if this wind energy installation is arranged at or in proximity to the collecting station and thus has the same phase angle as the latter. If there are still phase angle deviations, they can be identified and compensated for by this wind energy installation. Consequently, a fine tuning is also carried out, such that a phase angle of zero and thus freedom from reactive power prevail at the collecting station as a result. It goes without saying that at least one further wind energy installation of the wind farm is operated with the artificial voltage reference system according to the invention.

Advantageously, provision is furthermore made of a changeover module, which has an input for a local actual phase angle and an input for the reference angle and is configured to change over gradually from one input to the other input. It is thus possible to carry out adjustment continuously variably between the artificial, fictitious reference phase angle of the synthetic coordinate system, on the one hand, and the real local phase angle, on the other hand. This affords major advantages in particular upon the connection of wind energy installations. They can thus be operated at least initially with the phase angle actually present and then be continuously switched over later, during stable operation, to the external specification of the phase angle according to the invention.

In accordance with a further advantageous aspect of the invention, a particular specification of the reactive power to the individual wind energy installations is accordingly carried out. In the simplest embodiment, all wind energy installations operate with the same specified value. However, this is not absolutely necessary. It can also be provided that the wind energy installations adapt the specified value with regard to the reactive current in a load-dependent manner. In this way, wind energy installations operated with high load can contribute a lower reactive power, while such wind energy installations having low power can utilize their still sufficient reserves to contribute a higher reactive power. It can also be provided that the adaptation can be carried out depending on the voltage in the farm network. One particularly expedient type of adaptation, which merits independent protection, if appropriate, is that mutually adjacent wind energy installations obtain specified values varied in opposite directions. In this regard, by way of example, one of the adjacent installations can obtain a setpoint value for the reactive power infeed that is increased by a certain magnitude, while the adjacent installation obtains a setpoint value for the reactive power infeed that is correspondingly decreased in magnitude. A reactive power thus circulates between these two wind energy installations, as a result of which, given a suitable choice of the oppositely directly specified values, it is possible to achieve a compensation of impedances between these wind energy installations. This capability for local compensation of the impedances directly at the location of origin is a particular accomplishment of the invention.

The invention furthermore extends to a corresponding method for operating a wind farm.

### BRIEF DESCRIPTION OF THE DRAWINGS

The invention is explained by way of example below on the basis of a preferred embodiment. In the figures:

FIG. 1 shows a schematic view of a wind farm in accordance with one exemplary embodiment of the invention;

FIG. 2 shows equivalent circuit diagrams for a farm-internal network;

FIG. 3 shows a block diagram for the vector-based regulation of a wind energy installation;

FIG. 4 shows a functional diagram with respect to a plurality of wind energy installations in the wind farm in accordance with FIG. 1;

FIG. 5 shows a block diagram with respect to a feedforward controller;

FIG. 6 shows illustrations with respect to currents in coordinate systems;

FIG. 7 shows a block diagram with respect to a changeover module; and

FIG. 8 shows a functional view with respect to the reference angle in accordance with the changeover module.

### DETAILED DESCRIPTION OF THE INVENTION

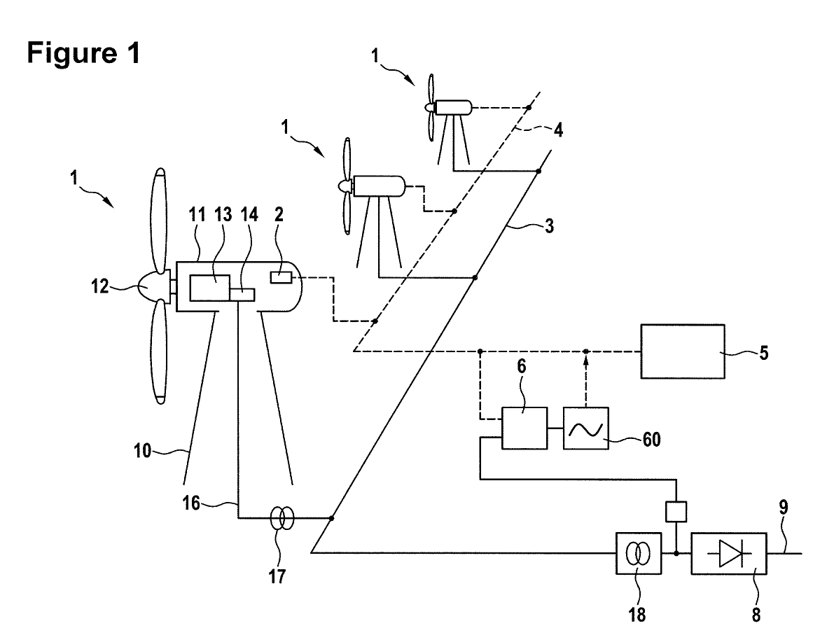

A wind farm in accordance with one exemplary embodiment of the invention is illustrated in FIG. 1. The wind farm comprises a plurality of wind energy installations 1 for generating electrical power, a farm-internal network 3, to which the wind energy installations 1 output the generated electrical power, a farm transformer 18, to which a farm-internal network 3 is connected, and a collecting station 8, which outputs to a transmission line 9 the electrical power generated by the wind energy installations 1 of the wind farm and collected via the farm-internal network 3. The farm-internal network is embodied as a three-phase network and the transmission line is preferably embodied as a high-voltage direct-current transmission (HVDC transmission) and a passive diode rectifier. A farm master 5 is provided for monitoring and superordinate control of the wind energy installations 1. Said farm master is connected to the individual wind energy installations 1 via a communication network 4. The three wind energy installations 1 illustrated in FIG. 1 should be considered to be merely by way of example; the wind farm can have significantly more wind energy installations. At the very least, however, it has two, preferably at least three, wind energy installations 1.

The wind energy installation 1 is embodied substantially conventionally. It comprises a tower 10 with a nacelle 11 arranged such that it can be pitched in the azimuth direction at the upper end of said tower. A wind rotor 12 is secured rotatably at an end side of the nacelle 11, said wind rotor driving a generator 13 for generating electrical power via a rotor shaft (not illustrated). The generator 13 is combined with a converter 14; they output the generated electrical power to the farm-internal network 3 via a connecting line 16 and an optional installation transformer 17. The converter 14 can be embodied as full converter or as partial converter (with a doubly fed asynchronous machine as generator). An operation controller 2 of the wind energy installation 1 is furthermore arranged in the nacelle 11. It is configured to monitor and to control the operation of the wind energy installation and the components thereof, in particular the converter 14. The controller 2 of the respective wind energy installation 1 is connected to the communication network 4 for communication with the farm master 5.

Furthermore, a dedicated, autonomously acting reference angle generator 6 is provided in the wind farm. Said reference angle generator comprises a frequency generator 60, which generates a reference voltage system and in particular a reference angle for a coordinate system defining an active and reactive axis of the wind energy installations 1 in the farm network 3. The frequency generator 60 thus creates a dedicated, quasi synthetic coordinate system and impresses it on the wind energy installations 1, which use it as a basis (possibly with modifications) for the outputting of the electrical power generated by them by means of the converter 14. Such a self-defined, synthetic coordinate system is suitable in particular for such wind farms which are connected to the interconnected electrical grid at remote locations and/or via a phase-blind connecting line (such as a DC transmission, for example HVDC transmission with passive diode rectifier). That applies in particular for application in offshore wind farms.

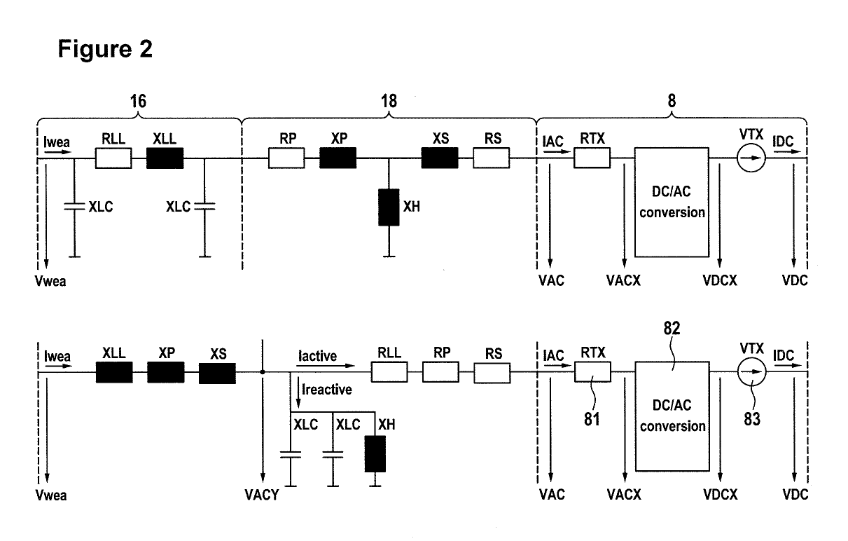

Reference is now made to FIGS. 2A, B, which illustrate alternative equivalent circuit diagrams for the farm-internal network 3 with components connected thereto. FIG. 2A illustrates a conventional equivalent circuit diagram, in which the impedance of the farm transformer 18 and that of the collecting station 8 are combined in order to simplify the impedances of the transmission lines 16 and of the lines of the farm-internal network 3 per se. The collecting station 8 is illustrated as a rectifier constructed with power diodes, wherein the power diodes are illustrated summarily by an equivalent resistance 81, an ideal diode 82 and a DC voltage source 83 as representative of the forward voltage.

The designations R and X and subsequent indices denote the ohmic inductive impedances, wherein the index LL stands for the lines per se, the index LC stands for the capacitive coupling thereof, the index P stands for the primary side of the farm transformer 18, the index S stands for the secondary side thereof, and the index H stands for the main field inductance thereof, and the index TX stands for the respective values at the collecting station 8. The voltage prevailing at the output of the wind energy installation 1 is designated as Vwea and the flowing current is designated as Iwea. The voltage in the three-phase network that is finally present at the input of the collecting station is designated as VAC and the current flowing there as IAC. The AC voltage present at the (ideal) diode 82 is designated as VACX and the DC voltage resulting therefrom after ideal rectification is designated as VDCX, from which a DC voltage value of VDC and a direct current of IDC result while taking account of the forward voltage by means of element 83.

For simple illustration it is expedient to group together elements of the same type, which then results in the equivalent circuit diagram in FIG. 2B. As a new value the voltage VACY is added here, describing the voltage at the coupling point between inductive, capacitive and resistive impedances. For the rest, the elements correspond to those illustrated in FIG. 2A.

It can be seen from the simplified illustration that it is the difference voltage VACY minus VACX which drives the current IAC and thus that is what defines the active power flow. The following applies to the active currents: if it is taken into consideration that the resistances in the ohmic group are comparatively low, then this means that even a comparatively small rise in VACY can bring about high active currents. The voltage VACX is dependent on the DC voltages VDCX and VDC of the HVDC transmission connection 9. The following applies in turn to the reactive currents: they result directly from the voltage VACY divided by the impedance of the impedances connected to ground. This current is comparatively low and broadly speaking results substantially passively from the active power operating point of the wind energy installation and the voltage VACY. Furthermore, the voltages VACY and Vwea are phase-shifted owing to the voltage drop across the inductive series impedances XLL, XP and XS on account of the wind energy installation current Iwea.

The invention makes use of this by impressing the active current by control of the voltage VACY, or, to put it more precisely, the voltage difference between VACY and VACX, wherein it should be taken into consideration that the voltage VACY is not a voltage that is measurable in reality. The reactive current is not impressed.

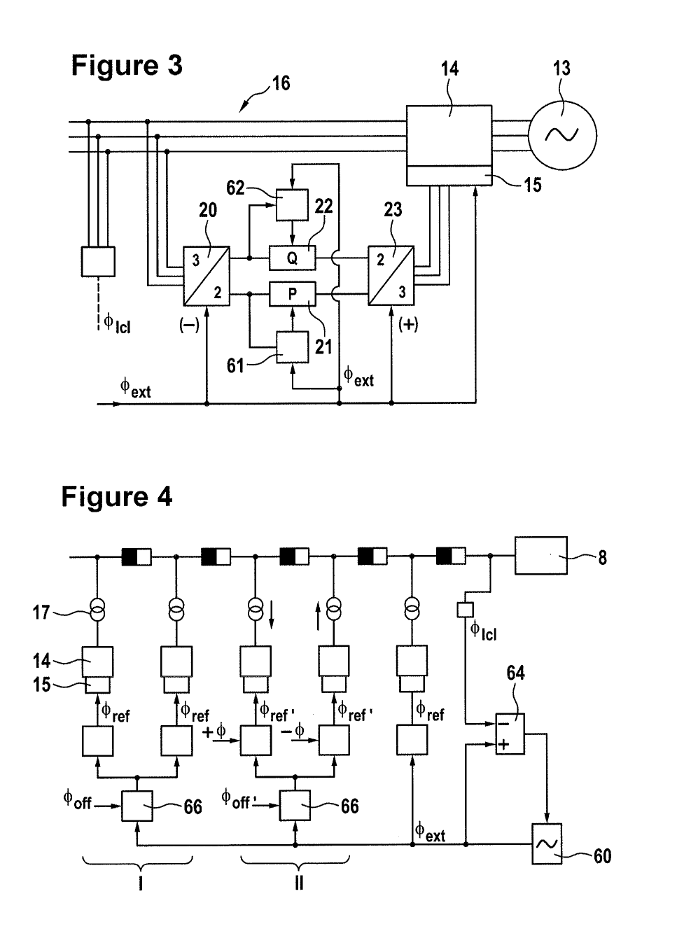

An important element here is that according to the invention the wind energy installation does not feed the electrical power generated by it into the farm-internal network 3 with the measured phase angle at the dedicated connecting line 16, but instead takes as a basis an externally specified phase angle. This externally specified phase angle is used in the vector-based regulation of the wind energy installation 1 and is visualized in FIG. 3.

Reference is now made to FIG. 3. The generator 13 is basically conventional, said generator being connected to a converter 14, and the latter in turn outputs the electrical power via the line 16 after conversion. By means of suitable sensors on the three lines of the three-phase system, voltages and currents are detected and applied to a block 20 for coordinate transformation. Said block 20 is configured to convert the values for voltages and currents detected in the three-phase system of the three-phase network into a two-axis coordinate system oriented to the rotation vector (so-called D, Q coordinates) and to rotate them backward (−) in terms of angle in the process in order thus to use them for regulating the active power (by means of regulators 21) and the reactive power (by means of regulators 22). The regulation of the active/reactive power is thus carried out in the D, Q coordinate system. Finally, it is necessary to provide an inverse transformation of the coordinate system again. The block 23 is provided for this purpose, which converts the two-axis coordinate system again into the three-phase system and correspondingly rotates it forward (+) in terms of angle in the process and on this basis applies the control signals to a controller 15 of the converter 14. For the coordinate conversion stationary/rotating or rotating/stationary, both the block 20 and the block 23 require information about the phase angle. The latter is conventionally determined from the phase actually present on the connecting line 16, measured as ϕ_{lcl}. This value is represented illustratively with a dashed line in FIG. 3. However, this value is not used for the coordinate transformation 20, 23 according to the invention. An externally specified (reference angle generator 6) phase angle ϕₑₓₜ is used instead. That means that the phase division of the currents according to active and reactive components is thus not carried out on the basis of the actual phase angle ϕ_{lcl} on the connecting line 16 of the wind energy installation 1, but rather on the basis of a—basically fictitious—externally specified phase angle ϕₑₓₜ.

This coordinate transformation and the coordinate systems taken as a basis are illustrated in FIG. 6. The coordinate system representing the conditions actually prevailing on the connecting line 16 is represented with solid lines. The reactive component (“react”) is represented on the abscissa and the active component (“act”) is represented on the ordinate. The external coordinate system generated synthetically by the reference angle generator 6 is represented with a dashed line. It differs from the real coordinate system in that it has a basically inherently arbitrary phase angle with respect to the real coordinate system (wherein the deviation should not be excessively large for reasons of expediency). An apparent current that is actually output by the converter 14 via the connecting line 16 is designated by I. The current is real and exists independently of which coordinate system is used for decomposition into active and reactive component, respectively. In the real coordinate system (with solid axes), this total current I can be decomposed into an actual active current component L_{act}_{_}_{lcl} and an actual reactive component I_{R}_{_}_{LCl} (represented with solid arrow lines). In the synthetically generated fictitious coordinate system, the same apparent current I is composed of a fictitious active current component I_{act}_{_}ₑₓₜ and a fictitious reactive current component I_{R}_{_}ₑₓₜ (represented by bold dashed arrow lines).

As is evident, the magnitudes of the active component and of the reactive component differ significantly between the representation in the real and fictitious coordinate systems. In the fictitious coordinate system, the magnitudes for the active and reactive currents result in accordance with the following relationships:

I_{act}_{_}ₑₓₜ=|I|*cos ϕ_{lcl}=|I|*cos(ϕₑₓₜ−Δϕ) (1)

I_{R}_{_}ₑₓₜ=|I|*sin ϕ_{lcl}=|I|*sin(ϕₑₓₜ−Δϕ) (2)

In this case, Δϕ is the difference between ϕₑₓₜ−ϕ_{lcl}. It can thus be stated that active current and reactive current are apportioned differently relative to the two coordinate systems, wherein the apparent current is the same in both cases.

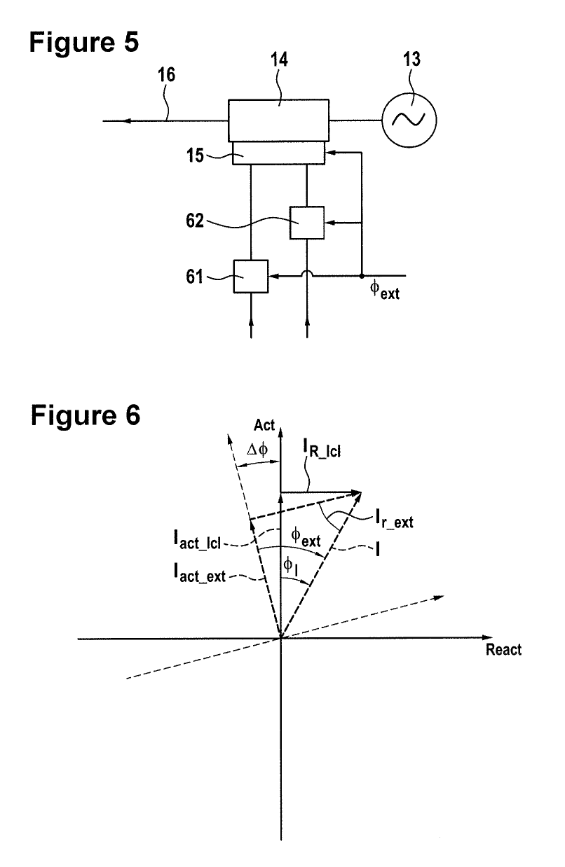

That also means, however, that given an assumed phase difference of Δϕ, the active current in the fictitious coordinate system always differs from the real active current in terms of magnitude in accordance with the above relationship; the same correspondingly applies to the reactive current. By virtue of the fact that according to the invention the external, synthetically generated fictitious phase angle is applied to the controller 2 of the wind energy installation 1, the active power regulators 21 and the reactive power regulators 22 also operate in the fictitious coordinate system. They thus regulate to a different magnitude of the active power (and of the reactive power, respectively) than would correspond to the actual conditions. The deviation resulting therefrom can lead to problems in the management behavior and in the system stability. In order to avoid this, the invention preferably provides a feedforward controller (see also FIG. 5). In this regard, firstly, an active power feedforward controller 61 is provided for the active power regulator 21. Said active power feedforward controller implements the relationship according to which the active current in the fictitious coordinate system differs from the real conditions in accordance with the relationship (1) indicated above. This is taken into account by the feedforward controller 61. It prevents the real and fictitious conditions with respect to the active current from diverging too much. The same correspondingly applies to the reactive current: in this case, a corresponding feedforward controller 62 for the reactive current is provided for the reactive power regulator 22.

Reference is now additionally made to FIG. 4. In order that the discrepancy to be bridged by the feedforward controller 61, 62 does not become too great, the angle difference Δϕ between the actual and fictitious coordinate systems should not become too great. For this purpose, a phase monitor 64 is preferably provided. It has two inputs, wherein the actual phase angle ϕ_{lcl} is applied to one input and the external phase angle ϕₑₓₜ generated by the reference angle generator 6 is applied to the other input. The phase monitor 64 forms the difference between said phase angles and compares it with a limit value that can be set. It is only if said limit value is exceeded that the phase monitor 64 outputs an actuating signal to the reference angle generator 6 in order that the phase angle thereof changes such that the difference is reduced to an extent such that it lies below the limit value that can be set. In this way, the two coordinate systems are prevented form diverging too far, which might otherwise lead to tilting away and hence to stability problems.

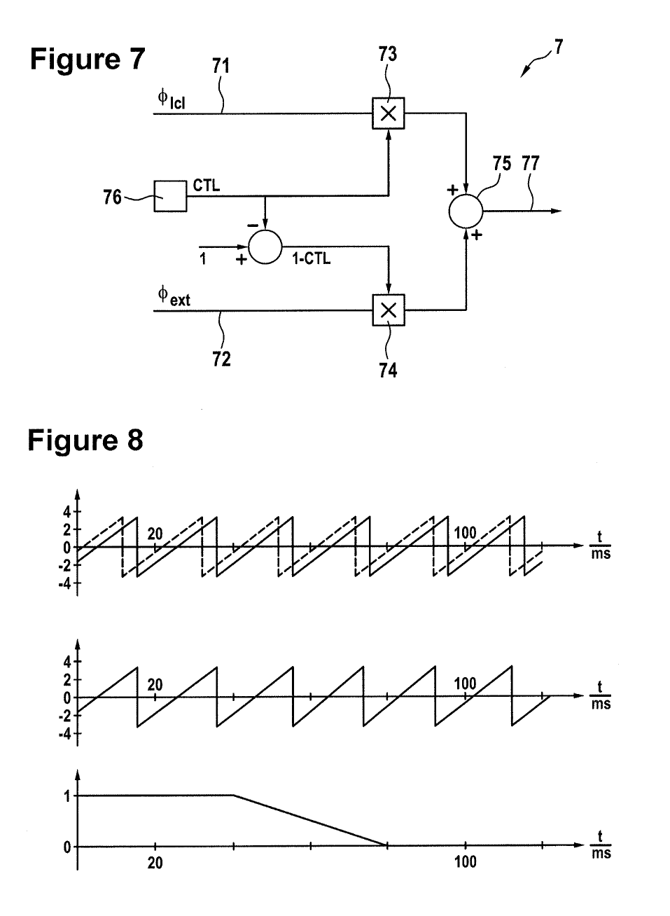

As is illustrated in FIG. 7, it can optionally be provided that in certain situations the wind energy installation 1 does not operate with the externally specified reference angle ϕₑₓₜ, but rather with the local reference angle. This may be advantageous in particular when the wind energy installation is started (start-up). In this case it is expedient if the wind energy installation 1 is operated with the phase angle in accordance with the actually prevailing conditions ϕ_{lcl}. In order to switch the wind energy installation 1 gently to the external reference angle ϕₑₓₜ after the start-up process, a changeover module 7 is preferably provided. The latter has an input 71 for the actual phase angle ϕ_{lcl} and an input 72 for the external phase angle ϕₑₓₜ. They are applied to a multiplication element 73 and 74, respectively. A control signal CTL is furthermore applied, which proceeds in a ramplike fashion from 0 to 1 for a mixing ratio of 0-100%. This value is applied in respectively opposite senses as multiplier to the two multiplication elements 73, 74. The outputs thereof are connected to a summation element 75, which finally generates the mixed output signal 77. A continuously variable transition between the local phase angle ϕ_{lcl} and the fictitious reference angle ϕₑₓₜ can be achieved in this way. The control signal CTL is generated by a start module 76.

The mode of operation of the changeover module 7 with the start module 76 is illustrated in FIG. 8. In FIG. 8A, the fictitious reference angle ϕₑₓₜ is represented with a dashed line and the actual phase angle ϕ_{lcl} is represented with a solid line. The control signal CTL is illustrated in FIG. 8C. It is initially at 1, meaning that the actual local phase angle ϕ_{lcl} is intended to be used 100%. The value of the control signal CTL then falls linearly in a ramplike fashion to a value of 0, which means that a switchover to the external reference angle ϕₑₓₜ is gradually made. The resulting output signal is illustrated in FIG. 8B. It is evident that a harmonic transition free of jumps takes place with regard to the phase angle.

The wind energy installations 1 of the wind farm can all be operated with the same external reference angle. However, this is not absolutely necessary. Provision can also be made for combining the wind energy installations 1 into groups I, II that are operated with different external reference angles (see FIG. 4). For this purpose, an offset module 66 is expediently provided in such groups. This is configured to alter the externally specified reference angle ϕₑₓₜ by an offset angle ϕ_{Off}. Furthermore, the offset angles can differ between the groups I, II, such that a group II is operated with a different offset angle ϕ_{Off}′.

The offset angle ϕ_{Off} need not be static, but rather can be varied by the offset module 66, for example depending on a voltage or an operating point of the respective wind energy installation. An adaptation can also be provided in such a way that reactive current circulates between preferably adjacent wind energy installations 1. As a result, it is possible to reduce or compensate for voltage drops in the farm network as a result of the intervening line impedances. For this purpose, provision is expediently made for altering the specifications for active current and in particular reactive current at the respective wind energy installations 1 in opposite directions by means of additional values. In this way, a locally circulating additional reactive current is generated, as is illustrated in FIG. 4 by the two arrows oriented in opposite directions at the wind energy installations arranged in the center.

1. A wind farm comprising a plurality of wind energy installations which each have a generator driven via a rotor and a converter for generating electrical energy and are connected to a farm internal network that connects the wind energy installations to a collecting station, wherein a central transmission line for connection to an energy transmission network is connected to the collecting station, wherein a phase angle (ϕ) is a measure of a phase shift between current and voltage in the farm-internal network, and wherein each wind energy installation has a controller for active/reactive power that acts on the respective converter based on the phase angle,
wherein the wind farm further comprises an autonomous reference angle generator that generates a reference angle (ϕₑₓₜ) for a coordinate system defining an active and reactive axis of the plurality of wind energy installations, and
wherein the converters of at least some of the plurality of wind energy installations are externally controlled in terms of phase by virtue of the reference angle (ϕₑₓₜ) generated by the reference angle generator being applied to the active/reactive power controller of the respective wind energy installation via a signal line.

2. The wind farm of claim 1, wherein an artificial coordinate system is formed with the reference angle (ϕₑₓₜ) of the reference angle generator, with a zero angle that is floating relative to a coordinate system of the farm-internal network.

3. The wind farm of claim 1, further comprising a phase monitor that is configured to detect an actual phase angle (ϕ_{lcl}) in the farm internal network, to form a difference between the actual phase angle (ϕ_{lcl}) in the farm internal network and the reference phase angle (ϕₑₓₜ), to compare the difference with a limit value, and to adjust the reference angle generator in response to the comparison indicating that the limit value has been exceeded.

4. The wind farm of claim 1, wherein the active/reactive power regulator of a respective wind energy installation comprises a feedforward controller that is configured to operate based on the difference angle (Δϕ) between the reference angle and an actual local phase angle.

5. The wind farm of claim 4, wherein the feedforward controller is configured to detect an active current actually output and to carry out a coordinate transformation into the artificial coordinate system.

6. The wind farm of claim 4, wherein the feedforward controller is configured to detect a reactive current actually output and to carry out a coordinate transformation into the artificial coordinate system.

7. The wind farm of claim 1, wherein the at least some of the plurality of wind energy installations have different reference phase angles due to a local offset for the reference phase angle.

8. The wind farm of claim 7, wherein the local offset is dependent on an operating point of the respective wind energy installation.

9. The wind farm of claim 1, wherein t the at least some of the plurality of wind energy installations are subdivided into groups (I, II), wherein the groups (I, II) have different reference phase angles.

10. The wind farm of claim 1, wherein at least one of the wind energy installations of the wind farm is operated with an actual phase angle as reference phase angle, wherein the actual phase angle at the collecting station is preferably applied to the at least one of the wind energy installations.

11. The wind farm of claim 1, wherein the active/reactive power controller of each wind energy installation comprises a changeover module that has an input for a local actual phase angle and an input for the reference phase angle and that is configured to change over from one input to the other input.

12. The wind farm of claim 11, wherein each wind energy installation comprises a start module that is configured to interact with the changeover module so that the respective wind energy installation is started up with the local phase angle and a changeover to the reference phase angle is then made during operation.

13. The wind farm of claim 1, wherein different specified values for the reactive power or reactive current are applied to the controllers of the at least some of the plurality of wind energy installations.

14. The wind farm of claim 1, wherein the collecting station is reactive-power-intolerant.

15. A method for operating a wind farm comprising a plurality of wind energy installations which each have a generator driven via a rotor with a converter for generating electrical energy and are connected to a farm-internal network that connects the wind energy installations to a collecting station, wherein a central transmission line for connection to an energy transmission network is connected to the collecting station, wherein a phase angle is a measure of a phase shift between current and voltage in the farm-internal network, and wherein the wind energy installations each have a controller for active/reactive power that acts on the respective converter depending on the phase angle, the method comprising:
generating a dedicated coordinate system in the wind farm via an autonomous reference angle generator,
defining a reference angle for an active and reactive axis in the farm network based on the generated dedicated coordinate system,
externally controlling, in terms of phase, the converters of at least some of the wind energy installations by virtue of a reference angle generated by the reference angle generator being applied to the active/reactive power controller of the respective wind energy installation via a signal line.

16. The wind farm of claim 13, wherein the different specified values for at least one of the reactive power and a reactive current are applied to the controllers of the at least some of the plurality of wind energy installations based on the local voltage.

17. The wind farm of claim 14, wherein the collecting station comprises a passive diode rectifier.
